(19) United States
(12) Patent Application Publication
(10) Pub. No.: US 2016/0046296 A1
(43) Pub. Date: Feb. 18, 2016

(54) METHOD AND DEVICE FOR ASSIGNING A DRIVER OF A VEHICLE TO A DRIVER CLASS STORED IN THE VEHICLE AND REPRESENTING A SPECIFIC DRIVING BEHAVIOUR OF THE DRIVER, AND COMPUTER PROGRAM PRODUCT FOR THAT PURPOSE

(71) Applicant: ROBERT BOSCH GMBH, Stuttgart (DE)

(72) Inventors: Andreas OFFENHAEUSER, Marbach Am Neckar (DE); Ernst SCHERMANN, Leinfelden-Echerdingen (DE)

(21) Appl. No.: 14/778,841

(22) PCT Filed: Feb. 6, 2014
(86) PCT No.: PCT/EP2014/052320

§ 371 Date: Sep. 21, 2015

(30) Foreign Application Priority Data
Mar. 20, 2013 (DE) 10 2013 204 882.3

(51) Int. Cl. B60W 40/09; H04W 4/00; H04M 1/725; B60R 16/037; B60W 50/00

(52) U.S. Cl. CPC B60W 40/09; B60R 16/037; B60W 50/0098; H04M 1/72527; H04W 4/008; B60W 2040/0827

(57) ABSTRACT

A method for assigning a driver of a vehicle to a driver class stored in the vehicle and representing a specific driving behavior of the driver after a driving pause includes identifying the driver based on an acquisition of data indicating an occupancy of only one seat of the vehicle before and after the driving pause, and/or based on an acquisition, before and after the driving pause, of a recognition code of a technological device assigned to the driver, and, based on the identification, using the driver class assigned to the identified driver.

### FIELD OF THE INVENTION

The present invention relates to a method for assigning a driver of a vehicle to a driver class stored in the vehicle and representing a specific driving behavior of the driver, and to a corresponding device, as well as to a corresponding computer program product.

### BACKGROUND

A tiredness recognition function, also referred to as Driver Drowsiness Detection (DDD), acquires the tiredness of drivers of vehicles through analysis of their steering behavior. Due to the fact that the steering behavior is markedly driver-dependent, for a robust recognition of tiredness, driver-specific patterns must be analyzed. In order to find these driver-specific patterns, in general a so-called driver classification is carried out at the beginning of the runtime of the function, or also continuously.

DE 103 21 750 A1 describes a system and a method for acquiring the identity of a vehicle occupant. A sensor module mounted in the vehicle contains an occupant sensor for obtaining an image of a body part of the vehicle occupant in order to identify the vehicle occupant.

### SUMMARY

Against this background, the present invention presents a method for assigning a driver of a vehicle to a driver class stored in the vehicle and representing a specific driving behavior of the driver, and a device that uses this method, as well as, finally, a corresponding computer program product.

A detection of an occupancy of only one seat of a vehicle before and after a driving pause, and a simultaneous or alternative detection of a recognition code of a technological device assigned to the driver before and after the driving pause, creates a possibility of unambiguously identifying the driver before and after the driving pause as the same person, in such a way that a renewed carrying out of a driver classification after the driving pause can be omitted.

According to the present invention, it can thus be ensured that even without carrying out a driver classification after starting a vehicle, another driver cannot be brought into association with the patterns (false for this driver) of the previous driver. Thus, for example, during highway travel, a brief rest stop, e.g., in the form of a coffee break, can be inserted without losing a tiredness history related to a driver, or driver-specific information.

In addition, in an example embodiment, a personalization of the tiredness function can be realized, for example in order to adapt warning thresholds of the function.

Thus, with the design presented herein it can be enough to carry out a driver identification only when a person acting as the sole driver of a vehicle is in fact unknown.

Advantageously, the method presented here can be realized using seat occupancy recognition and multimedia systems with wireless linkage, which have become standard equipment in many mid-class and luxury class vehicles, without installing additional components in the vehicle.

According to an example embodiment, a method for assigning a driver of a vehicle to a driver class stored in the vehicle and representing a specific driving behavior of the vehicle after a driving pause includes identifying the driver based on an acquisition of an occupancy of only one seat of the vehicle before and after the driving pause, and/or on an acquisition of a recognition code of a technological device assigned to the driver before and after the driving pause in order to assign the driver to the driver class.

The vehicle can be a roadway vehicle such as a passenger automobile or truck. The driver class can be a driving pattern that can be represented using unambiguous data. In particular, the driving pattern can describe a steering behavior of the driver from which, using a suitable system, indications of tiredness, incipient tiredness, or, in contrast, alertness and optimal attentiveness of the driver with regard to traffic activity can be obtained. Based on the indications, for example a warning or recommendation to the driver can then be outputted. For example, the driver can be given the recommendation to interrupt or terminate the driver's trip, because the driver's capacity to drive appears to be limited due to tiredness, and if the driver were to continue to travel, the driver could present a danger to the driver's self and/or to other traffic participants. Here, the driver class can be so complex that it can be unambiguously assigned to one person, from a plurality of possible persons, as the driver of the vehicle. A driver classification for assigning a driver to a particular driver class can for example be carried out using a suitable algorithm. The driving pause can be identified by the switching off of an engine of the vehicle before the driving pause and starting the engine again after the driving pause. The driving pause can be a relatively brief interruption of a trip, such as a coffee break. The driving pause can however also be a non-use of the vehicle of longer duration, e.g., days, weeks, or months. In the step of identification of the driver, the driver can be unambiguously selected from a plurality of possible drivers. In the acquisition of the occupancy of only one seat, it can in particular be detected that the seat is occupied by a person situated on a seat mat of the seat. In an example embodiment, a significant feature is to determine that before the driving pause only one seat of the vehicle is occupied and after the driving pause again only one seat of the vehicle is occupied. In particular, the seat can be, in each case, the driver's seat of the vehicle. The technological device assigned to the driver can for example be a mobile telephone or a small portable computer, such as a PDA. The technological device can be characterized by being unambiguously attributable to the driver, so that the driver's identity can be determined beyond doubt. The method can be carried out in order to ensure that a driver of the vehicle after the driving pause is identical to the driver of the vehicle before the driving pause. The method can be carried out by or in association with a central control device of the vehicle.

According to an example embodiment of the method, in the step of identification, the occupancy of the seat is acquired by a detection of a specific weight on a seating mat of the seat and/or a detection of a fastening of a safety belt assigned to the seat. Because many vehicles are already standardly equipped with systems for seat occupancy recognition, in this way already-existing resources can be used for an additional purpose, saving costs.

According to a particular example embodiment, in the step of identification, the recognition code can be acquired via a radio interface with a mobile telephone assigned to the driver of the vehicle. The radio interface can for example be a Bluetooth interface. In this example embodiment as well, the fact can advantageously be exploited that many vehicles are already standardly equipped with a multimedia system with wireless linkage, so that for the realization of this example embodiment no costs, or only slight costs, arise.

In addition, in the step of identification of the driver, identification can take place based on an agreement of a first driving speed profile, acquired before the driving pause, with a second driving speed profile acquired after the driving pause, and/or based on an agreement of first navigation data, acquired before the driving pause, with second navigation data, acquired after the driving pause. The navigation data can be information of a navigation device of the vehicle, for example relating to a destination of a trip of the vehicle. This example embodiment offers a possibility of verification, which can be carried out very easily and quickly, that the driver before and after the driving pause is the same person.

In particular in the step of identification, the driver class can represent a steering behavior of the driver characterized by tiredness of the driver. Correspondingly, the driver class can be assigned to the driver in order to determine a tiredness of the driver. Depending on the realization of this example embodiment, with the assignment of the driver class, a presence or absence of tiredness of the driver can be determined. If the driver-specific pattern represented by the driver class is stored in the system in such a way that, e.g., a steering behavior in the case of safe driving is used as an initial basis, then for example a tiredness, or incipient tiredness, of the driver can be determined if there is a deviation from the stored steering behavior. If, in contrast, the driver-specific pattern represented by the driver class is stored in the system in such a way that, e.g., a steering behavior in the case of unsafe driving is used as an initial basis, then correspondingly a tiredness, or incipient tiredness, of the driver can be determined if the driver's steering behavior corresponds to or resembles the stored steering behavior. Here, in order to exclude false interpretations or confusion, a tiredness history specific to the driver and that has been created for example over a multiplicity of trips of this driver with this vehicle can be stored in the system with the driver class.

In an example, the method can have a step of adapting the driver class based on a response and/or input by the driver in response to a question relating to the driver class. This specific embodiment enables an advantageous personalization of the method. The method can thus easily be expanded with a trainability component, and in this way can advantageously be improved.

In particular, if the driver class represents a steering behavior of the driver characterized by a tiredness of the driver and the question is a question concerning a feeling of tiredness on the part of the driver, a warning threshold for a tiredness warning to the driver can be changed in the step of adaptation, in particular raised, if the response and/or input from the driver is a negative answer to the question. In this example embodiment of the personalization of the method, the driver class can be adapted still more precisely to an individual person.

Advantageously, in this way warnings that could under some circumstances disturb the driver can be avoided.

Alternatively, in the step of adaptation, a change in the navigation data can take place if the driver class represents a steering behavior of the driver characterized by a tiredness of the driver, the question is a question concerning a feeling of tiredness of the driver, and the response of the driver to the question is positive. This example embodiment of the personalization of the method also enables a driver class adapted still more optimally to an individual person. The advantage here is that the driver is incorporated into a decision finding, and that the avoidance of danger is realized rapidly through the change in the navigation data.

According to an example embodiment, a device for assigning a driver of a vehicle to a driver class stored in the vehicle and representing a specific driving behavior of the vehicle after a driving pause includes an apparatus for identifying the driver based on an acquisition of an occupancy of only one seat of the vehicle before and after the driving pause, and/or based on an acquisition of a recognition code of a technological device assigned to the driver before and after the driving pause in order to assign the driver to the driver class.

The device can be a central control device of the vehicle or can be a device coupled to the central control device. The device can be fashioned to carry out or realize the steps of the method according to the present invention in the corresponding apparatus. Through this variant embodiment of the present invention in the form of a device as well, the object of the present invention can be achieved quickly and efficiently.

In an example embodiment, the device is an electrical piece of equipment that processes sensor signals and, as a function thereof, outputs control signals and/or data signals. The device can have an interface that can be fashioned as hardware and/or as software. In the case of a realization as hardware, the interfaces can for example be part of a so-called system application specific integrated circuit (ASIC) that contains a wide variety of functions of the device. However, it is also possible for the interfaces to be separate integrated circuits, or to be made up at least partly of discrete components. In the case of a realization as software, the interfaces can be software modules that are present for example on a microcontroller alongside other software modules.

Also advantageous is a computer program product having program code that can be stored on a machine-readable bearer such as a semiconductor storage device, a hard drive storage device, or an optical storage device, and is used to carry out the method according to one of the example embodiments described above when the program product is carried out on a computer or on a device.

Example embodiment of the present invention are explained below in more detail on the basis of the accompanying drawings.

### BRIEF DESCRIPTION OF THE DRAWINGS

FIG. 1 shows a schematic representation of a vehicle including a device for assigning a driver of the vehicle to a driver class stored in the vehicle and representing a specific driving behavior of the driver, according to an example embodiment of the present invention.

FIG. 2 is a flowchart illustrating a method for assigning a driver of a vehicle to a driver class stored in the vehicle and representing a specific driving behavior of the driver, according to an example embodiment of the present invention.

FIG. 3 shows a functional diagram illustrating the operation of the method of FIG. 2, according to an example embodiment of the present invention.

### DETAILED DESCRIPTION

In the following description of preferred example embodiments of the present invention, identical or similar reference characters are used for elements shown in the various figures that have similar function, and repeated description of these elements is not given.

FIG. 1 shows a schematic representation of a vehicle 100 according to an example embodiment of the present invention. The vehicle 100 includes a device 102 for assigning a driver 104 of vehicle 100 to a driver class 106 stored in vehicle 100 and representing a specific driving behavior of driver 104. Driver class 106 can be stored in a driver database in which there is stored a plurality of different driver classes for a plurality of different possible drivers of vehicle 100. Here, each of the driver classes characterizes a specific steering behavior of the driver assigned thereto. Thus, after successful driver identification, i.e., unambiguous assignment of a driver to a specific steering behavior, a tiredness recognition can be carried out for this particular driver.

As FIG. 1 shows, device 102 includes an apparatus 108 for identifying driver 104. Apparatus 108 is connected via electrical lines to a seat occupancy recognition unit 110 of vehicle 100, and is coupled to a radio interface 112 of a multimedia system installed in the vehicle. Seat occupancy recognition unit 110 is fashioned to acquire an occupancy of a seat 114, here the driver's seat, of vehicle 100. Seat occupancy recognition unit 110 can be fashioned to acquire the seat occupancy via a detection of a weight that is placed on a seat mat (not shown in FIG. 1) of seat 114. Alternatively or in addition, seat occupancy recognition 110 can however also be fashioned to infer that seat 114 is occupied from a detection of a fastening of a safety belt 116 assigned to seat 114. If seat occupancy recognition unit 110 determines that, before a driving pause of vehicle 100, driver's seat 114 was occupied as the sole occupied seat of vehicle 100, and that also after the driving pause driver's seat 114 is again exclusively occupied, then apparatus 108 identifies the person occupying driver's seat 114 as one and the same driver, before and after the driving pause, of vehicle 100. Correspondingly, device 102 automatically assigns to driver 104 the driver identification 106, already determined before the driving pause. A duration of the driving pause can be from a few minutes up to several days, weeks, or months. The driving pause can be characterized by a switching off of an engine of vehicle 100 before the driving pause, and a restarting of the engine after the driving pause.

Radio interface 112, coupled to apparatus 108, of the vehicle multimedia system can be a Bluetooth interface via which a recognition code of a technological device 118 can be acquired that can be assigned to a person seated in the vehicle. In the scene shown in FIG. 1, technological device 118 is a mobile telephone carried on the person of driver 104 of vehicle 100. If a recognition code acquired before the driving pause via radio interface 112 agrees with a recognition code, acquired via radio interface 112 after the driving pause, of technological device 118, then apparatus 108 identifies driver 104 as a person identical to a driver before the driving pause. In the example embodiment of device 102 explained on the basis of the representation in FIG. 1, driver 104 is identified twice, i.e., via seat occupancy recognition unit 110 and radio interface 112. Alternatively, it is also possible for the identification of driver 104 to take place solely via seat occupancy recognition unit 110 or solely via radio interface 112.

After driver class 106 has been assigned to driver 104, then a tiredness recognition can be started for driver 104 immediately after the driver has reentered the vehicle after a driving pause, or can be continued after the interruption by the driving pause.

As explained above, whether driver 104 is traveling alone in vehicle 100 can be checked through the seat occupancy on the basis of an acquired weight on the seat mat, or on the basis of a determination of a fastening of belts. If only one person, i.e., driver 104, is in vehicle 100, then in addition, through an analysis of a speed profile or navigation data, it can be excluded that a change of driver has taken place during a coffee break. Thus, for example, during a stop at a highway rest stop, it can be assumed that no change of driver has taken place if, before and after the pause, in each case only one person is in the vehicle, because it is improbable that, in the case of a passenger car, there has been a change of driver 104. Thus, as already explained, the driver classification does not have to be restarted.

In the example embodiment including radio interface 112, driver 104 can be unambiguously identified again even after several days via coupled Bluetooth device 118, e.g., the mobile telephone. If only one person 104 gets into vehicle 100, and couples a cell phone 118 with a known Bluetooth address, it can be assumed that this is the same person 104.

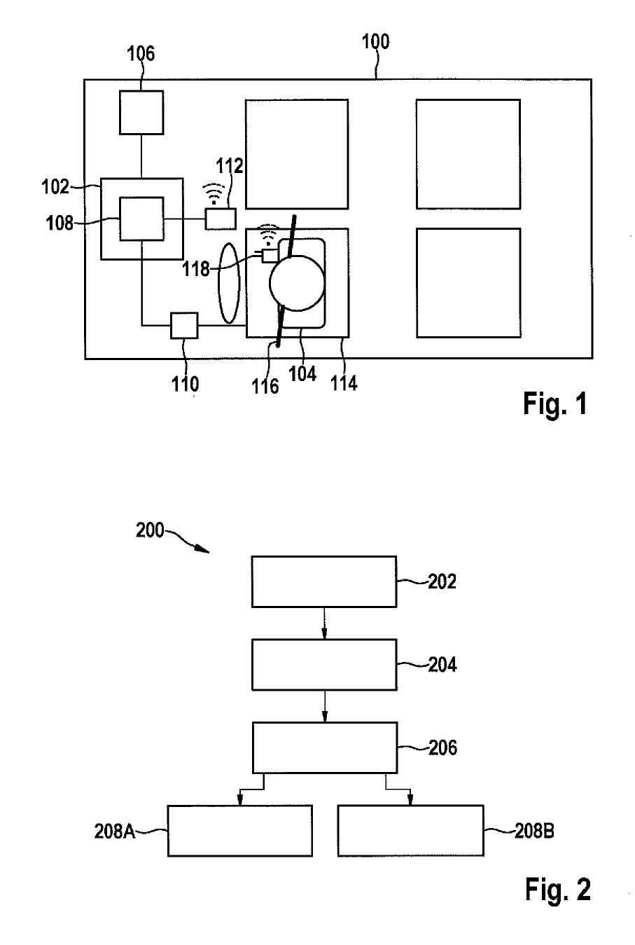

FIG. 2 is a flowchart illustrating an example embodiment of a method 200 for assigning a driver of a vehicle to a driver class stored in the vehicle and representing a specific driving behavior of the driver. In a step 202, the method determines that only one seat of the vehicle is occupied both before and after a driving pause. Additionally or alternatively, a recognition code of a technological device assigned to the driver is acquired both before and after the driving pause. Based on the information acquired in step 202, in a step 204 the driver is identified in order to assign to the driver the driver class that represents the driver's specific driving behavior. In a step 206, a question relating to the driver class is directed to the driver of the vehicle in order to adapt the driver class in a manner dependent on an answer from the driver. In a step 208A the method performs a first adaptation of the driver class if the answer from the driver contains a negative response to the question. In a step 208B the method performs a second adaptation of the driver class, that is different from the first adaptation, if the answer from the driver contains a positive response to the question.

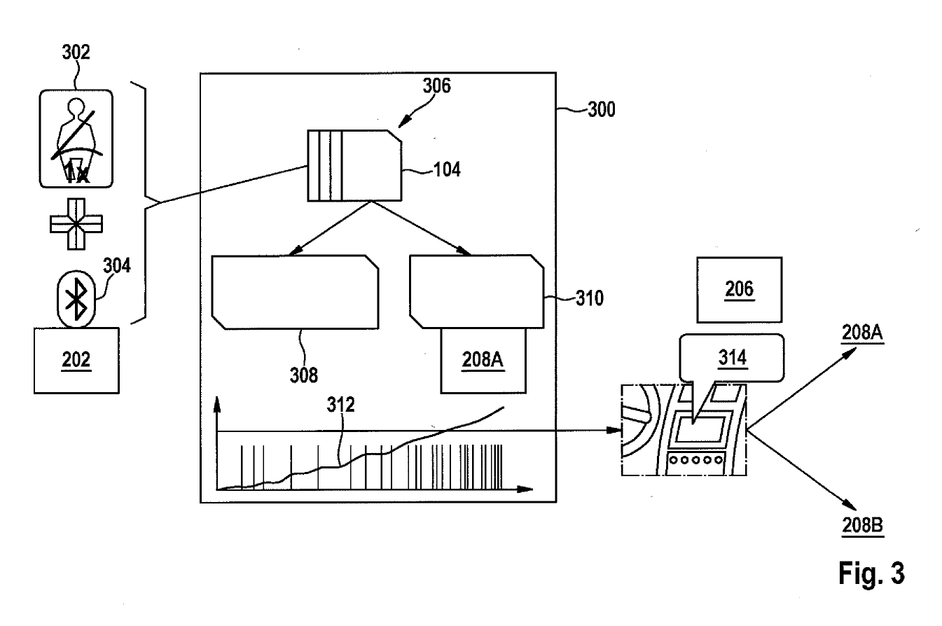

FIG. 3 shows a functional diagram illustrating the method of FIG. 2. The method is here used for a personalization of a tiredness recognition 300. Step 202 of the method explained in FIG. 2 is, as symbolized by the ‘+’ symbol, carried out in the embodiment shown in FIG. 3 using both verifications, i.e., including the acquisition of the occupation of only one seat of the vehicle before and after the driving pause, symbolized by a pictogram 302, and the acquisition of a recognition code of a technological device assigned to the driver before and after the driving pause, symbolized by a Bluetooth symbol 304. As pictogram 302 shows, here the occupancy of only one seat in the vehicle is acquired through detection of a fastening of a safety belt. Based on the information acquired in step 202, there takes place, based on the identification of driver 104 selected from a plurality of possible drivers 306, and an assignment, identified by an arrow, of driver 104 to driver class 308 representing the driver's specific driving behavior, which class was determined through a driver classification carried out in the past. A warning level or warning threshold 310 is assigned to driver class 308. If warning threshold 310 is exceeded, which is represented in FIG. 3 by a predefined curve of a graph 312 entered in a coordinate system, then a warning is output to driver 104, for example as an instruction to interrupt travel and to take a break. With the personalization of the method, in step 206 a question 314 is directed to driver 104, for example, “Are you tired?.” If driver 104 answers “no” to question 314, then the method continues with step 208A, in which the first adaptation of driver class 308 takes place in the form of a shifting of warning threshold 310 for future trips. If driver 104 answers “yes” to question 314, then the method continues with step 208B, in which the second adaptation of driver class 308 takes place in the form of a modification of the navigation data.

FIG. 3 illustrates that the recognition or identification of driver 104 enables a personalization of tiredness function 300, in order for example to adapt warning threshold 310 of function 300. In an example embodiment, the method queries a correctness of an output tiredness warning for an adaptation of warning threshold 310, for example by outputting to the driver question 314 of “Are you tired?” as illustrated in the example embodiment of the method shown in FIG. 3. Based on the response of driver 104, threshold 310 can then be adapted for the next tiredness warning.

In principle, the type of driver identification described herein, i.e., using information concerning a seat occupancy and a Bluetooth device, can also be used for other functions in the vehicle that require a personalization.

The example embodiments described and shown in the figures have been chosen only as examples. Different example embodiments can be combined with each other in their entirety or with regard to individual features. One example embodiment can also be supplemented with features of a further example embodiment.

In addition, method steps according to the present invention can be repeated, and can be carried out in a sequence differing from that described.

If an example embodiment contains an “and/or” linkage between a first feature and a second feature, this is to be read as meaning that according to one example embodiment, both of the first and second features are included, and according to another example embodiment, only one of the first and second features are included.

1-10. (canceled)

11. A method for using, after a driving pause, a driver class that is stored in a vehicle in association with a driver of the vehicle and that represents a specific driving behavior of the driver, the method comprising:
obtaining, by processing circuitry, data including at least one of (i) information indicating an occupancy of only one seat of the vehicle, the obtaining of the information occurring both before and after the driving pause and (ii) a recognition code of a technological device assigned to the driver, the obtaining of the recognition code occurring both before and after the driving pause;
based on the obtained data, determining, by the processing circuitry, that a driver change has not occurred during the driving pause;
based on the determination, identifying, by the processing circuitry, that the driver, in association with whom the driver class is stored, is driving the vehicle after the driving pause;
based on the identification, selecting, by the processing circuitry, the driver class; and
generating, by the processing circuitry, a driver customized output based on the selected driver class.

12. The method of claim 11, wherein the information indicating the occupancy is obtained in the obtaining step, and the obtaining includes detecting at least one of a specific weight on a seat mat of the seat and an application of a safety belt assigned to the seat.

13. The method of claim 11, wherein the recognition code is obtained in the obtaining step via a radio interface of a mobile telephone assigned to the driver of the vehicle.

14. The method of claim 11, wherein the determining is further based on an agreement of a first driving speed profile, acquired before the driving pause, with a second driving speed profile, acquired after the driving pause.

15. The method of claim 11, wherein the determining is further based on an agreement of first navigation data, acquired before the driving pause, with second navigation data, acquired after the driving pause.

16. The method of claim 11, wherein:
the driver class represents a driver specific relationship of steering behavior to driver tiredness;
the method further comprises using the selected driver class to determine a tiredness of the driver; and
the driver customized output is based on the tiredness determination.

17. The method of claim 1, further comprising:
modifying the driver class based on a driver input received in response to a question.

18. The method of claim 17, wherein the modification includes modifying a threshold for outputting a tiredness warning.

19. The method of claim 18, wherein:
the driver class represents a driver specific relationship of steering behavior to driver tiredness;
the question is whether the driver feels tired; and
the modification includes raising the threshold in response to a negative response to the question.

20. The method of claim 1, wherein:
the driver class represents a driver specific relationship of steering behavior to driver tiredness; and
the method further comprises outputting a question inquiring whether the driver feels tired and modifying the driver class and navigation data in response to a positive response to the question.

21. A device of a vehicle, the device comprising:
a data store in which a driver class is stored in association with a driver of the vehicle, the driver class representing a specific driving behavior of the driver; and
processing circuitry with access to the data store, wherein the processing circuitry is configured to:
obtain data including at least one of (i) information indicating an occupancy of only one seat of the vehicle, the information being obtained both before and after a driving pause and (ii) a recognition code of a technological device assigned to the driver, the recognition code being obtained both before and after the driving pause;
based on the obtained data, determine that a driver change has not occurred during the driving pause;
based on the determination, identify that the driver, in association with whom the driver class is stored, is driving the vehicle after the driving pause;
based on the identification, select the driver class; and
generate a driver customized output based on the selected driver class.

22. A non-transitory computer-readable medium on which are stored instructions that are executable by a processor and that, when executed by the processor, cause the processor to perform a method for using, after a driving pause, a driver class that is stored in a vehicle in association with a driver of the vehicle and that represents a specific driving behavior of the driver, the method comprising:
obtaining data including at least one of (i) information indicating an occupancy of only one seat of the vehicle, the obtaining of the information occurring both before and after the driving pause and (ii) a recognition code of a technological device assigned to the driver, the obtaining of the recognition code occurring both before and after the driving pause;
based on the obtained data, determining that a driver change has not occurred during the driving pause;
based on the determination, identifying that the driver, in association with whom the driver class is stored, is driving the vehicle after the driving pause;
based on the identification, selecting the driver class; and
generating a driver customized output based on the selected driver class.
